(19) United States
(12) Patent Application Publication
(10) Pub. No.: US 2013/0339055 A1
(43) Pub. Date: Dec. 19, 2013

(54) DEVICE, METHOD AND DATA READER FOR HANDLING TREATMENT-RELATED DATA

(71) Applicant: Fresenius Medical Care Deutschland GmbH, Bad Homburg (DE)

(72) Inventors: Pia DANIEL, Bodman (DE); Marco GRAEFE, Bad Homburg (DE); Michael LUCKAU, Lohmar (DE); Helmut STEIL, Gelnhausen (DE)

(73) Assignee: Fresenius Medical Care Deutschland GmbH, Bad Homburg (DE)

(21) Appl. No.: 13/917,981

(22) Filed: Aug. 20, 2013

Related U.S. Application Data
(60) Provisional application No. 61/660,100, filed on Jun. 15, 2012.

(30) Foreign Application Priority Data
Jun. 15, 2012 (DE) 102012011790.6

(51) Int. Cl. G06F 19/00

(52) U.S. Cl. CPC G06F 19/322
USPC 705/3

(57) ABSTRACT

A method for handling treatment-related data on a patient in a clinic data management system (10), which is connected to a preparation station (14) for preparing for treatment of a patient and to a treatment station (15) for treatment of a patient is disclosed. A data reader (20) is wirelessly connectable to the preparation station (14) and to the treatment station (15). The data reader (20) is suitable for entering treatment-related data. The method comprises the following steps:
connecting the data reader (20) to the preparation station (14),
entering treatment-related data at the preparation station (14) using the data reader,
checking (214) the treatment-related data entered at the preparation station,
connecting the data reader to the treatment station,
entering (210) treatment-related data at the treatment station using the data reader (20),
using the treatment-related data for preparing for treatment of a patient at the treatment station.

### TECHNICAL FIELD

The invention relates to a method for handling treatment data, a method for handling patient data and treatment data, a data reader for use in one of these methods and a clinic data management system for implementing one of these methods.

### BACKGROUND

In everyday clinical practice, clinic data management systems are being used to an increasing extent. These systems are used for management, allocation and processing of patient data, treatment data, diagnostic data and other data generated in or required for the treatment of patients. Dialysis clinics are a prominent example of the use of clinic data management systems. Dialysis machines in such a clinic are networked together by being connected to a local area network and tied into a clinic data management system. In this case, a clinic data management system typically consists of one or more server computers for managing and allocating patient data, treatment data, diagnostic data or other data pertaining to a dialysis treatment. Data sources may include a dialysis machine, electronic scales, a blood gas analyzer or other data sources which record data based on a dialysis treatment or on another treatment of a patient and can be relayed to a server computer via a network interface. In a typical clinical data management system, it is possible to access patient data, treatment data, diagnostic data and the like from a client's computer or an administration computer. Data stored on a server computer can be exchanged with a database for archiving or for data collation. Barcode scanners are currently being used as data readers for input of treatment-related data. In the past, such barcode scanners have been fixedly connected to a certain workstation so that the handling of the treatment-related data is inflexible and tedious to some extent. The object of the present invention is therefore to provide a method and a data reader which will enable flexible and simple handling of patient data.

### SUMMARY

This object is achieved by a method for handling treatment-related data in a clinic data management system which is connected to a preparation station for preparing for treatment of a patient and to a treatment station for treating a patient, such that a data reader is wirelessly connected to a preparation station and to the treatment station, said data reader being suitable for entering treatment-related data. This method comprises the following steps:

connecting the data reader to the preparation station, entering treatment-related data at the preparation station using the data reader,
checking the treatment-related data entered at the preparation station;
connecting a data reader to the treatment station, entering treatment-related data at the treatment station using the data reader; and
using the treatment-related data for preparing for a treatment of a patient at the treatment station.

Advantageous refinements of the aforementioned method are characterized in the dependent claims.

In addition, the object defined above is achieved by a data reader for entering treatment-related data in a clinic data management system for use in a method for handling treatment-related data according to Claim 1, wherein the data reader can be connected to preparation station for preparing for the treatment of a patient and to a treatment station for treating a patient, each via a wireless radio connection.

Advantageous refinements of the aforementioned data reader are characterized in the dependent claims.

This object is also achieved by a clinic data management system according to any one of Claims 15-17 and a computer program product according to Claim 18.

### BRIEF DESCRIPTION OF THE DRAWINGS

Additional details consistent with the teaching of the invention are therefore described in greater detail on the basis of the drawings, in which:

FIG. 1 shows a block diagram of a few elements of a clinic data management system.

FIG. 2 shows a flowchart of a typical sequence in preparation for a treatment with the help of the clinic data management system according to FIG. 1.

FIG. 3 shows another flowchart of another typical sequence in preparation for a treatment with the help of the clinic data management system according to FIG. 1.

FIG. 4 shows a flowchart of another typical sequence of a preparation for a treatment with the help of the clinic data management system according to FIG. 1.

### DETAILED DESCRIPTION OF THE DRAWINGS

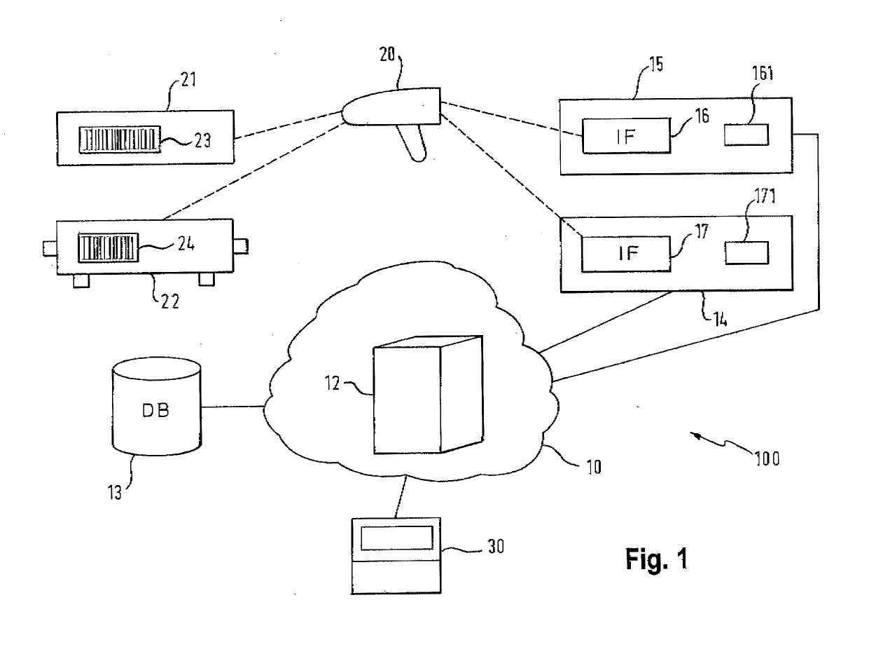

FIG. 1 shows a clinic data management system 100 in which various elements can communicate with one another with the help of a clinic network 10. A clinic network 10 may have a local area network, for example, or some other network in which the network elements communicate with one another using the Internet protocol. A preparation station computer 14 is connected to the clinic network at a preparation station for preparing for treatment of a patient, and a treatment station computer 15 is connected to the clinic network at a treatment station for performing the treatment of the patient. The treatment may be a dialysis treatment, for example, and the treatment station computer may be the computer of a machine for performing an extracorporeal blood treatment. Various blood purification methods have become established in renal replacement therapy; in these methods, the blood is freed extracorporeally of blood constituents that must be eliminated in the urine, i.e., blood constituents which are eliminated via the kidneys in a healthy person. In hemodialysis, there is a diffusive mass transport of substances that are present in blood and must be eliminated in urine into a dialysis fluid through a semipermeable membrane. The mass transport takes place through the semipermeable walls of a dialyzer, which has a blood chamber connected to an extracorporeal blood circulation and a dialysis fluid chamber connected to a dialysis fluid circulation.

The blood chamber and the dialysis fluid chamber are separated by the semipermeable membrane. To prevent diffusive loss of electrolytes, which should remain in the blood, the dialysis fluid contains a certain composition of electrolytes in a physiological concentration.

On the other hand, in hemofiltration there is convective mass transport through a semipermeable membrane of a filter, in which a pressure gradient on the membrane is the driving force for the mass transport. To compensate for a loss of desired blood constituents, the electrolytes lost through the membrane must be replaced by a substituate fluid. A combination of convective transport with diffusive transport is known as hemodiafiltration. If dialysis or a dialysis treatment is mentioned in the context of this patent application, this should be understood to refer to a purely diffusive dialysis or hemodiafiltration. Accordingly, a dialysis machine should be understood to be a machine for performing a purely diffusive dialysis or a machine for performing a hemodiafiltration treatment.

The preparation station computer 14 comprises an interface 17 and the treatment station computer 15 comprises an interface 16, the two interfaces 17, 16 being suitable for connecting a data reader 20 and for entering handler-related data or treatment-related data for use in the clinic data management system. In addition, the data reader may also be suitable for input of patient data. For example, the interfaces 17, 16 may be wireless interfaces such as Bluetooth interfaces. The data reader 20 may be a barcode reader or a barcode scanner, for example. In this case, the handler-related data may be entered by scanning in an identification of a handler or operator from an identification card 21 of the handler or operator, wherein identification data on the handler or operator is encoded in a barcode 23. In another exemplary embodiment, the handler-related data is stored in an RFID (radio frequency identification) chip and can be input from the RFID chip by using an RFID reader.

In addition, the data reader may be suitable for entering treatment-related data, for example, for entering data of consumable material to be used during a treatment or data on a medication to be administered during a treatment. In this case the data reader may also be embodied as a barcode reader or a barcode scanner and the treatment-related data may be encoded as a barcode, for example, as a barcode applied to a medication package or as a barcode applied to a consumable material. In the case of the dialysis treatment, the consumable material used may be, for example, the dialyzer 22 that is to be used in a treatment. Other examples of consumable materials for a dialysis treatment include a tube set such as a blood tube set or a cassette having a plurality of elements of an extracorporeal blood circulation integrated into it. All these consumable materials may be provided with a barcode 24 or with an RFID chip for identification of the corresponding consumable material. The barcode 24 may be a linear barcode or a two-dimensional barcode.

Furthermore, interfaces 161 and 171 may be provided for entering patient data such as identification data for a patient on the treatment station computer 15 and the preparation station computer 14, for example, when the storage media used for handling patient data are different than the storage media used for handling treatment-related data or for handler-related data. For example, chip cards or cards provided with magnetic strips may be used for storing patient data, so that corresponding readers are provided as interfaces 161 and 171 for output of patient data.

A clinic network typically includes one or more network servers 12 which offer services within the clinic data management system. Such services may include, for example, accepting applications of a patient to a network element of the clinic data management system 10 or responding to inquiries from a client computer 30.

The server 12 may be connected to a database 13 for providing services through said server. The database 13 typically manages patient-related data, in other words, patient data such as: patient identification data, age, date of birth, gender, diagnostic data such as weight, nutritional status, blood gas values or treatment-related data such as treatment profiles, or in the case of the dialysis treatment, for example, treatment profiles, which stipulate the ultrafiltration profile to be used during a treatment.

Another example of a treatment profile in a dialysis treatment is a time profile of an electrolyte concentration in the dialysis fluid such as a concentration profile of sodium, potassium, magnesium or calcium. Other treatment-specific data may include the medication to be administered during the treatment or the dialyzer to be used during a treatment.

Furthermore, treatment-related data may be stored on the network server 12 together with identification data of a handler or an operator for documentation of a treatment that has been administered.

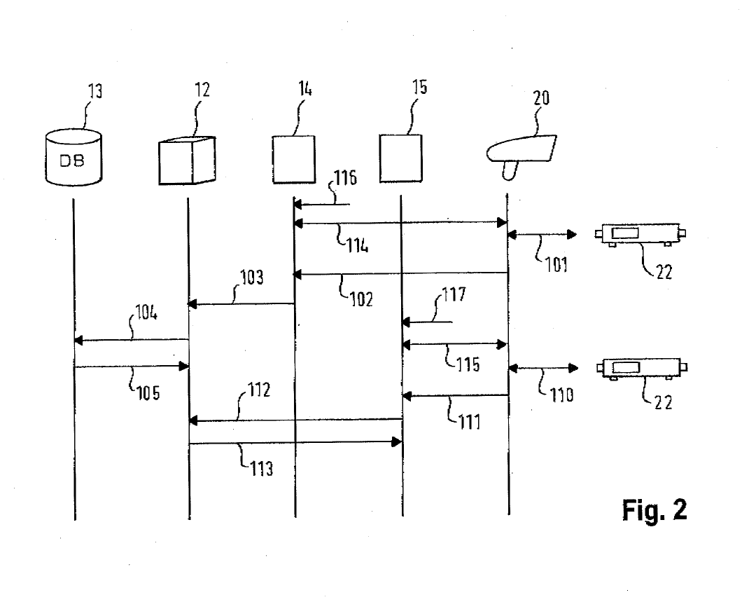

FIG. 2 shows another typical exchange of messages in a clinic data management system 100 according to FIG. 1, in which a patient logs onto a preparation station for preparing for a treatment at a patient treatment station. Corresponding elements in the clinic data management system are labeled with corresponding reference notation. Instead of repeating the information, reference is now made to the description of these elements in conjunction with FIG. 1.

To prepare for the treatment of the patient, identification data on the patient is first entered at the preparation station in an input step 116. This may be accomplished through a manual input of patient identification data with the help of a keypad on the preparation station computer 14 or by entering stored identification data on the patient with the help of the interface 171. Thus the interface 171 may be designed as a magnetic strip reader or a chip card reader for input of patient identification data stored on the magnetic strip or on a memory chip, for example. After the information data on the patient has been entered, the data thereby entered can then be assigned to the proper patient.

There follows the input of treatment-related data using the data reader 20. To do so, the data reader 20 is connected to the preparation station computer 14 in a connecting step 114. In the case of a wireless connection between the data reader and the preparation station computer, this may be done, for example, by placing the data reader close to the interface 17, which in this case is embodied as a wireless interface. As a result or after an additional manual operation, a connection is established for a short-range wireless connection such as a Bluetooth connection. The details of establishing such a connection are familiar to the skilled person and need not be reproduced here. The treatment-related data can be entered after the data reader has been connected to the preparation station computer. The treatment-related data may be encoded as a barcode on consumable goods to be used during the treatment, the input of the treatment-related data being accomplished by entering the barcode. The barcode may be a linear barcode or a two-dimensional barcode. In another exemplary embodiment, treatment-related data is stored on an RFID (radio frequency identification) chip and can be entered from the RFID chip using an RFID reader. Again in this case, the data reader can be wirelessly connected to the preparation station. After the treatment-related data has been entered 101 using the reader 20, the treatment-related data can be transmitted to the preparation station computer 14 over the connection (step 102). Then a query 103 is sent from the preparation station computer 14 to the network server 12 for preparing for treatment at the treatment station. The query 103 contains the treatment-related data. The server 12 then sends a query 104 to the database 13 to the network server for checking the treatment-related data. The database 13 then responds with a reply message 105 confirming the validity of the treatment-related data or indicating a lack of validity. The validity of the treatment-related data in this context may mean that the expiration date for the treatment means thereby identified has not yet been exceeded and the treatment means can still be used and/or that it does not belong to a batch that has been recalled. A lack of validity may mean that the expiration date has been exceeded for the treatment means and it can no longer be used or that the treatment means belongs to a batch that has been recalled.

The server 12 receives the response message and saves its contents together with the patient identification data.

Then the patient may log onto the patient treatment station. To do so, the patient's identification data is entered in an input step 117 at the treatment station. This may be accomplished by manual input of patient identification data with the help of a keypad on the treatment station computer 14 or by entering the patient's identification data stored previously with the help of the interface 161. In this way, the interface 161 may be embodied as a magnetic strip reader or as a chip card reader for entering patient identification data stored on a magnetic strip and/or on a memory chip. After the patient's identification data has been entered, the data thereby entered can then be assigned to the corresponding patient.

Then the data reader 20 is connected to the treatment station computer 15 in a connection step 115, for example, by establishing a short range wireless connection between the data reader and the treatment station. Then treatment-related data can be entered using the data reader 20 in an input step 110, for example, by scanning a barcode of a medication to be administered during the treatment or of consumable goods to be used during the treatment as described above. Then with a query 112, the validity of the treatment-related data can be queried by the server 12 from the treatment station computer 15. The query 112 contains the patient identification data and/or the treatment-related data that has been input. In the server 103 the validity of this treatment-related data can be retrieved on the basis of the treatment-related data. The server 12 replies with an answer 113, which indicates the validity of the patient's treatment-related data. Then the answer 113 of the server 12 is received at the treatment station computer, and the validity of the treatment-related data is ascertained. If the validity of the treatment-related data has been ascertained, treatment of the patient can be initiated at the treatment station, utilizing the treatment-related data.

In the case of a slower connection between the server computer 12 and the database 13, the validity of the treatment-related data can be ascertained promptly in chronological proximity to the treatment station computer without having to wait a corresponding waiting time on the treatment station computer.

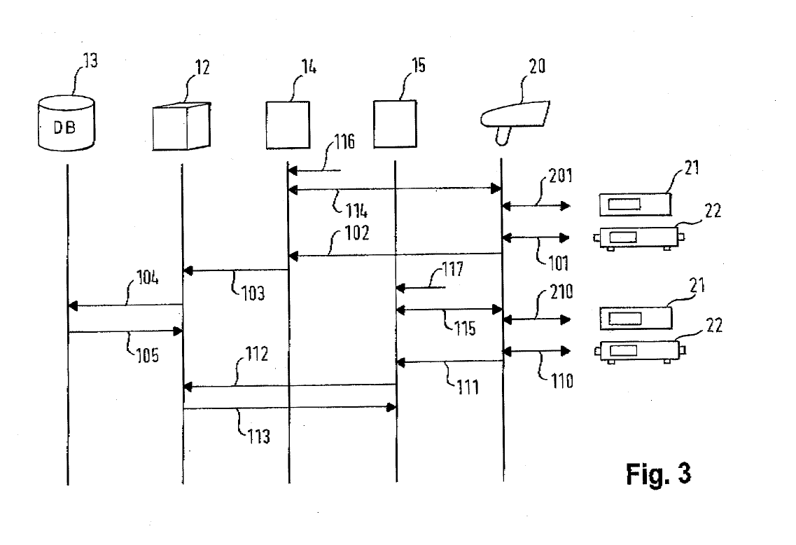

FIG. 3 shows another typical message exchange in a clinic data management system according to FIG. 1, in which a patient login and registration of consumable material take place at a preparation station, for preparing for treatment at a patient treatment station. Corresponding elements in the clinic data management system are provided with corresponding reference numerals.

Reference is made to the description of these elements in conjunction with FIG. 1 instead of repeating the description here.

The sequence shown in FIG. 3 supplements the exchange of messages illustrated in FIG. 2. Reference is made to the description of the steps which correspond to the sequence described in conjunction with FIG. 2 instead of repeating the description here.

The sequence described in conjunction with FIG. 3 supplements the sequence described in conjunction with FIG. 2 to the extent that the data reader 20 is suitable for input of handler-related data such as identification data for a handler or an operator, such as a dialysis nurse in the case of a dialysis machine as the treatment station.

After the data reader has been connected to the preparation station, identification data for a handler or an operator can be entered in a step 101 in the method depicted in FIG. 3. This data can be transferred to the preparation station computer 14 together with the other data entered by the data reader in the message 102. From there, the handler-related data can be forwarded to the server 12 for documentation, for example. In this case, the documentation would confirm that the handler or operator identified on the basis of the identification data has performed the preparation for the treatment at the preparation station 15.

Furthermore, there is the possibility of checking on permission for a handler or operator for the planned treatment on the basis of the identification data entered for said handler or operator. For example, in the case of a dialysis treatment for certain types of treatment, a corresponding qualification of the handler or the operator may be necessary and the existence of this qualification could be stored in the database 13 together with the corresponding identification data. In this case, the messages 103 and 104 could include the identification of the operator or the handler, and the response messages 105 and 113 could contain an indicator for whether or not the qualification for the planned treatment is met. As an alternative, the identification of the handler or the operator and his/her qualification for the treatment to be performed can also be transmitted with corresponding separate messages.

Additionally or alternatively, the identification data on the handler or operator can also be entered in logging onto the treatment station computer 15 in a step 111. The identification data on the handler or the operator entered at the treatment station may in this case be stored together with other treatment data for documentation of the fact that the respective handler has performed this treatment. Corresponding documentation data may be stored in the server 12, for example.

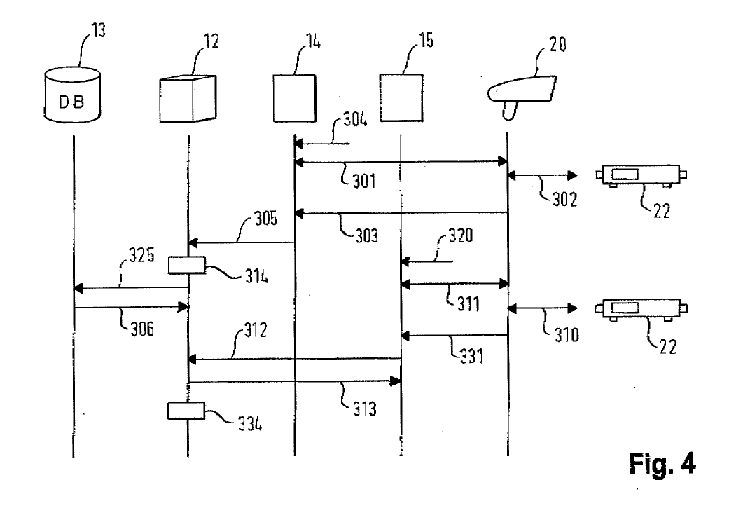

FIG. 4 shows another typical message exchange in a clinic data management system according to FIG. 1, in which a patient message and a registration of consumable material are performed at a preparation station in preparation for a treatment at a patient treatment station. Corresponding elements in the clinic data management system are provided with corresponding reference numerals. Reference is made here to the description of these elements in conjunction with FIG. 1 instead of repeating the description here.

To log a patient onto a machine for a treatment and to prepare for the treatment, the patient identification data is entered first in an input step 304. This step corresponds to the input step 116 already described in conjunction with FIG. 1. Reference should be made to this description instead of repeating the description here.

The treatment-related data to be entered as described below may thus be assigned to the patient identified by the patient identification data.

Then in a connection step 301, the data reader 20 is connected to the preparation station computer 14. Logging the data reader onto the preparation station computer corresponds to the input procedure described in conjunction with FIG. 2, to which reference will be made here instead of repeating the description.

After the data reader 20 has been connected to the preparation station computer 14, the treatment-related data may be entered.

The treatment-related data may be encoded as barcode 24 on a medication to be used during the treatment or on consumable material 22 to be used during the treatment or on an RFID chip. The barcode may be linear or two-dimensional.

In any case, the data reader can be wirelessly connected to the preparation station. After input 302 of the treatment-related data using the reader 20, the treatment-related data can be transmitted over the connection to the preparation station computer (step 303).

The treatment-related data thereby input is assigned to the patient to be treated, who is identified by the previously input patient identification data.

Next a query 305 is sent from the preparation station computer to the network server 12 in preparation for the treatment at the treatment station. The query 305 contains the patient identification data and the treatment-related data. Alternatively, the treatment-related data and the patient identification data can be sent in separate queries or in separate messages to the network server. The network server then performs a comparison 314 of the patient identification data and the treatment-related data. This comparison includes, for example, a check on whether the treatment-related data belong to a treatment which is provided for the patient. For example, the treatment-related data may include identification data for identifying a certain medication. In this case, the step of comparison of the patient identification data and the treatment-related data will include a step of checking on whether this medication is prescribed for the patient. Furthermore, the comparison may include a check on whether the medication identified has exceeded the expiration date or whether it belongs to a batch that has been recalled.

The comparison may also include a corresponding check when the treatment-related data is used for identification of consumable materials to be used during a treatment. Thus in a dialysis treatment, for example, there can be a check on whether the dialyzer identified by the treatment-related data has been prescribed for the patient, whether it belongs to a recalled batch or the like.

To perform the comparison, the server 12 may send a query 325 to the database 13, wherein the query 325 contains the treatment-related data and the patient identification data. In this case, the comparison would be based on the data stored in the database, for example, the treatment profiles stored in the database with medicines prescribed for a patient or the consumable materials prescribed for a patient, for example, a type of dialyzer to be used during a dialysis treatment.

The database responds with a response message 306 containing the result of the comparison step. The server 12 receives the response message and stores the result of the comparison step together with the patient identification data.

Then the patient can log onto the patient treatment station in a log-on step 320. To do so, the identification data of the patient may be entered manually or the patient identification data may be entered from a data carrier.

The treatment-related data to be input subsequently may thus be assigned to the patient identified by the patient identification data.

Then in a connection step 311, the data reader 20 is connected to the treatment station computer 15, e.g., by establishing a short-range wireless connection between the data reader 20 and the treatment station computer 15 to enter treatment-related data into the data reader 20 in an input step 310, for example, by scanning a barcode of a consumable material to be used during the treatment, as described above. The treatment-related data is transmitted in a step 331 from the data reader 20 to the treatment station computer 15. Then the result of the comparison of the patient identification data with the treatment-related data can be queried by the server 12 with a query 312. The query 312 contains the patient identification data and optionally also the treatment-related data entered in step 310.

In a step 334, the treatment data thereby input together with the patient identification data and additional data pertaining to the treatment to be performed may be stored in a documentation step 334.

The result of the comparison step can be retrieved from the server 12 on the basis of the patient identification data. Thus, for example, the patient may be accepted for treatment at the treatment station computer only if, for example, the medication provided for treatment of the patient has also been prescribed for the patient and has not yet expired. Or a dialysis treatment can be enabled only if the prescribed dialyzer has been prescribed for that patient and has not been recalled. The result of the comparison step is transmitted with the response message 313.

Consumable material whose identification data has previously been input at the preparation station can be used. In the subsequent treatment at the treatment station. Thus, for example, a dialysis treatment may be performed using a dialyzer whose identification data had previously been input.

In the case of a slower connection between the server computer 12 and the database 13, treatment data can be made available promptly at the treatment station computer without having to wait a corresponding waiting time at the treatment station computer.

1. A method for handling treatment-related data in a clinic data management system (10), which is connected to a preparation station (14) for preparing for treatment of a patient and to a treatment station (15) for treatment of a patient, wherein a data reader (20) is wirelessly connectable to the preparation station (14) and the treatment station (15), and the data reader (20) is suitable for entering treatment-related data, comprising the following steps:
connecting (101) the data reader (20) to the preparation station (14),
entering (101) treatment-related data at the preparation station (14) using the data reader (20),
checking (103;104) the treatment-related data input at the preparation station,
connecting the data reader to the treatment station,
entering (110) treatment-related data at the treatment station (15) using the data reader (20),
using the treatment-related data for preparing for treatment of a patient at the treatment station (15).

2. The method for handling treatment-related data according to claim 1 for preparing for treatment of a patient at the treatment station, comprising the following steps:
entering patient data at the preparation station (14),
comparing (314) the patient data thereby entered and the treatment-related data entered at the preparation station.

3. The method according to claim 1, wherein the method is a method for preparing for a dialysis treatment, and the treatment station (15) comprises a dialysis machine, and wherein the treatment-related data is based on a dialyzer to be used in a dialysis treatment.

4. The method according to claim 2, wherein the treatment-related data pertains to a medication to be used during the treatment, and wherein the step of comparison (314) is a comparison between a medication prescribed for the patient and the medication data input.

5. The method according to claim 1, wherein the treatment-related data pertains to a medication to be used during the treatment, and wherein the step of checking on the input medication data checks on whether the medication belongs to a batch that has been recalled.

6. The method according to claim 2, wherein the step of comparison (314) comprises a comparison between a type of dialyzer prescribed for the patient and the dialyzer data input.

7. The method according to claim 3, comprising the step of checking on whether the input dialyzer data relates to a recalled batch.

8. The method according to claim 1, wherein the data reader (20) is a barcode reader.

9. The method according to claim 1, wherein the data reader (20) can be connected to the treatment station (15) and to the preparation station (14) via a wireless radio connection.

10. The method according to claim 1, wherein the data reader is suitable for input of handler-related data comprising the following steps:
input of handler-related data at the preparation station or at the treatment station, use of the handler-related data and the treatment-related data for documentation of the treatment of the patient.

11. A data reader (20) for input of treatment-related data in a clinic data management system (10) for use in a method for handling treatment-related data according to claim 1, wherein the data reader (20) can be connected to a preparation station (14) for preparing for the treatment of a patient and a treatment station (15) treatment of a patient, each via a wireless radio connection.

12. A data reader (20) for input of treatment-related data in a clinic data management system (10) for use in a method for handling treatment-related data according to claim 1, wherein the data reader (20) can be connected to a preparation station (14) for preparing for the treatment of a patient and a treatment station (15) treatment of a patient, each via a wireless radio connection, and wherein the data reader is, suitable for input of handler-related data comprising the following steps:
input of handler-related data at the preparation station or at the treatment station, use of the handler-related data and the treatment-related data for documentation of the treatment of the patient.

13. The data reader according to claim 11, wherein the data reader (20) is embodied as a barcode scanner (20).

14. The data reader (20) according to claim 11, wherein the wireless connection is a connection according to the Bluetooth standard.

15. A clinic data management system (10) for handling treatment-related data, comprising a preparation station (14) for preparing for the treatment of a patient and a treatment station (15) for treatment of a patient as well as a data reader (20), which is wirelessly connectable to the preparation station (14) and to the treatment station (15), wherein the data reader (20) is suitable for input of the treatment-related data and wherein the preparation station (14) has an interface (17) for wireless connection to the data reader (20), for input of treatment-related data at the preparation station (14) with the data reader;
the clinic data management system (10) comprises a network server (12) for checking on the treatment-related data; the clinic data management system (10) comprises a treatment station (15) with an interface (16) for wireless connection of the data reader (20) for input of the treatment-related data at the treatment station (15) using the data reader (20), and wherein the treatment station (15) is adapted for use of the treatment-related data, for preparing for a treatment of a patient at the treatment station (15).

16. The clinic data management system (10) for handling of treatment-related data of a patient according to claim 15, wherein the data reader (20) is suitable for input of handler-related data, and wherein the network server (12) is suitable for use of treatment-related data and handler-related data for documentation of the treatment of a patient at the treatment station (15).

17. A clinic data management system (10) for handling treatment-related data, comprising a preparation station (14) for preparing for the treatment of a patient and a treatment station (15) for treatment of a patient as well as a data reader (20), which is wirelessly connectable to the preparation station (14) and to the treatment station (15), wherein the data reader (20) is suitable for input of the treatment-related data and wherein the preparation station (14) has an interface (17) for wireless connection to the data reader (20), for input of treatment-related data at the preparation station (14) with the data reader;
the clinic data management system (10) comprises a network server (12) for checking on the treatment-related data; the clinic data management system (10) comprises a treatment station (15) with an interface (16) for wireless connection of the data reader (20) for input of the treatment-related data at the treatment station (15) using the data reader (20), and wherein the treatment station (15) is adapted for use of the treatment-related data, for preparing for a treatment of a patient at the treatment station (15), adapted for performing a method according to claim 2.

18. A computer program product comprising program code parts adapted for performing a method according to claim 1.
